(19) United States
(12) Patent Application Publication
(10) Pub. No.: US 2007/0050278 A1
(43) Pub. Date: Mar. 1, 2007

(54) Trading rights facility

(76) Inventors: J. Peter Steidlmayer, Wilmette, IL (US); Keith D. Bronstein, Chicago, IL (US); Burt Gutterman, Glencoe, IL (US)

Correspondence Address: Paul E. Schaafsma;NovusIP, LLC, Suite 221, 521 West Superior Street, Chicago, IL, 60610-3135, US

(21) Appl. No.: 11/211,058

(22) Filed: Aug. 24, 2005

(51) Int. Cl. G06Q 40/00

(52) U.S. Cl. 705/37

(57) ABSTRACT

The trading rights facility of the present invention comprises guaranteeing an access for the quantity and price of a potential imbalanced or complex order, which price is acceptable to both the buyer, the seller, and the market as a whole; and agreeing to fully deliver the quantities at the discovered price within a pre-set delayed time frame. In effect, the trading rights facility of the present invention creates a secondary “liquidity base” that augments the ordinary access liquidity base, and allows for that initial liquidity base to remain untouched by the complex order itself, which is in sharp contrast to current experience where it would take all and ask for more. The initial liquidity base would be there to cushion the access community. The complex access would be at a premium to current market price and would be competitively bid in relation to the whole of the initial liquidity base environment. The trading rights facility of the present invention ensures the transparency of all operations. The trading rights facility of the present invention further allows for the creation for a variable access index product that also provides a supply zero sum diffusion base. In a further embodiment, the trading rights facility of the present invention allows a contract on a settlement price to be traded before the settlement price has been derived.

### FIELD OF THE INVENTION

The present invention relates to a trading rights facility.

### BACKGROUND OF THE INVENTION

A variety of different types of contracts are traded on various exchanges and other markets throughout the world. A cash contract is a sales agreement for either immediate or deferred delivery of the actual equity or commodity. An option is a contract that conveys the right, but not the obligation, to buy or sell a particular equity, commodity or futures contract on an equity or commodity at a certain price for a limited time. A call option is an option that gives the buyer the right, but not the obligation, to purchase the underlying equity, commodity or futures contract at a certain price (known as the strike price) on or before the expiration date. A put option is an option that gives the option buyer the right, but not the obligation, to sell the underlying equity, commodity or futures contract at the strike price on or before the expiration date.

A futures contract is a legally binding agreement, typically entered into on or pursuant to the rules of an exchange, to buy or sell an asset (such as a equity or a commodity) sometime in the future. A commodity (which may be a financial instrument) is generally an article of commerce or a product that can be used for commerce. An equity is generally an ownership interest in an asset such as stock in a company. In a narrow sense not intended for use herein, futures, options, and stocks are contracts for products traded on formally organized exchanges. Access to contracts all relate to time in some way. It is necessary to use time out forward as an uncertain base so that price itself can be free to discover. Stock access uses price earnings multiples; commodity access uses forward contract; and options as a derivative have additional imbedded time within the contract. The types of commodities commonly include agricultural products such as corn, soybeans and wheat; precious metals such as gold; fuels such as petroleum; foreign currencies such as the Euro; financial instruments such as U.S. Treasury securities; and financial indexes such as the Standard & Poor's® 500 stock index, to name a few. Standard & Poor's® 500 stock index is disseminated by Standard & Poor's, 55 Water Street, New York, N.Y. 10041 Unlike cash commercial contracts, futures contracts very rarely result in delivery, because most are liquidated by offsetting positions prior to expiration. Even stock trading has shifted from physical delivery to one of electronic recording.

Both stock and commodity marketplaces use another form of time in that both use a representative but limited supply to represent the availability of the whole, as the whole would be impossible to assemble. This concept of a representative but limited supply to represent the availability of the whole is referred to herein as the “float” of the marketplace. In stocks the float is called a book—where orders above and below the market are entered and are run by a specialist who in turn is required to use his capital in the same manner; in commodities multiple brokers have decks that are the same as a book for registration of orders above and below. In the past, the orders above and below were greater than any one or series of orders thus allowing access to a market through a price from the normal discovery mechanism of pricing efficiency. Also, orders were sufficiently simply that float adequately served in that representative role. In today's markets, however, the float is not large enough to serve in that needed role, as many orders are greater than it. A larger float would be good, but is really not a practical solution given today's market structure. Orders today can be much larger than or more complex than in the past, and the opportunity is to be able to deal directly with these new needs as they relate to competitive price access.

A common feature of standard contracts related to access is that the differential can be and is focused upon on price, due to the creative uses of time-distance from supply concerns. For example, futures contracts are standardized according to the quality, quantity, duration, delivery time, and delivery location for each commodity. The quality, quantity, duration, delivery time, and delivery location for each contract are fixed so that the price becomes the single variable. This is due to the fact that standard contracts are designed in order to achieve maximum liquidity, which creates conditions necessary for price efficiency and thus efficient access: if the supply element were variable (i.e. the market focus), the contract would be seeking supply first, before any price consideration, and prices in this scenario would be non-random in character. The relationship of supply-to-price in standard contracts is one where price measures the current or cumulative demand related to the whole of that supply, allowing individuals to assess price versus their particular needs (price discovery), which then serves other market functions—that is to ration usage, and to always assure an available supply. Without supply there can be no price—so if supply then is questioned, the market is then forced to secure supply before the market looks to find price. When this happens, on-going operations related to price-efficiency have to stop; therefore, supply security is paramount to any marketplace.

The prices applied to these standard contracts are universal in that they convey the same message to participants as well as those on the sideline who are not involved in a particular transaction: the collective view of market users on how to measure or assess current risk within the market as a whole for the underlying referenced contract. Over the years, the risk chain associated with demand—another time forward technique—has grown dramatically in the number and magnitude of risks. The normal situation for referenced supply—float—is to have a singular price-measured risk from all the elements of the risk chain (excluding those of a catastrophic nature—which are more sudden or immediate and can not be discounted through time as can other more normal risk—and which are thus normally supply related). It is the shifting influence between related demand risks among the various forward influences that makes price available through market access. This is called random activity. It is the basis of liquidity, which is so desirous in standard contracts.

The increased risk chain has made it very difficult to isolate reduction of risk so that opportunity can be greater than immediate market cost. Thus, standard contracts are mostly adversarial in nature in that there is no advantage for either party at the time of the transaction; but standard contracts do represent a “zero-sum” effect over time as an advantage materializes to one of the parties (see discussion on zero sums, below). Many different types of risks are assumed upon activation of the contract, and the risks fully apply until cancellation of the contract. It is the new growing number of risks within a broader or expanding risk chain that are related to supply that are the most difficult with which to deal, as they create pricing differentials that are much larger than demand pricing differentials thus forcing a structural problem of internal imbalance upon what is supposed to be a balanced environment. The market pricing structure related to access is not designed to deal with uncertainty related to supply, so as these risks and others (e.g., a trader desirous of some supply) enter the marketplace; a new way of dealing with these changes has to be forthcoming.

Any contract that was just beneficial to a single party would have to be placed and could not typically be traded in a formal centralized exchange auction. Standard contracts face a threat of diminished real usage because of these newly introduced factors related to supply, and a distinct rising of the hidden cost of zero sums resulting from the lack of such usage (less fragmentation and less turnover). Risk assumption outside of price or getting beyond price, is now related to owning the whole of supply, or some supply that has been partialized, as time is needed to find a replacement versus other immediate market needs.

To overcome the new higher price risk assumptions, the trend within the industry has been to work with more of a supply variance. Supply has leverage over price and allows design to overcome the higher imbedded risk from that risk chain. Markets are dealing with float that represents supply—when an imbalance of buy/sell orders arrives and overwhelms the book as well as normal specialist function related to continuous developing markets, that market is forced to shut down, communicate the supply imbalance to potential buyer/sellers (as the case may be), and once a balance related to supply is again found the market is reopened so the pricing function can proceed. This demonstrates then the leverage that supply has over price. Price change to price change in random conditions does not offer leverage; any leverage relates only to external forms such as margins etc. Supply to price creates an internal market leverage. The price access that we have now is very functional and needed, and all future access would like to incorporate its features into buying and selling; however, price access was designed for passive supply activity, and with supply now more active, price access cannot work as designed.

In addition to price being the most commonly referred to differential of standard contracts, the nature of the use of price in standard contracts further reinforces its weight. Because traders typically can buy exchange-traded standard contracts on margin, price enjoys a leveraged position in standard contracts. This external leverage also serves as an additional medium that assures randomness by making prices changes more uncertain. In addition, price has always had a far greater magnitude in the minds of traders than the amount of the contracted commodity, because price relates directly to their ability to access or define opportunity within the standard contract, while quantity remains more of a personal decision. Still further, because there is no actual need to deliver the underlying referenced commodity at the time a standard contract is traded, supply has been relegated to a lesser variable than price because supply is just faintly in the background. For these and other reasons, in standard contracts supply has been not an element of equal weight to price. Therefore, any change in supply status from nominal will affect markets in ways that can only be detrimental to random access.

Supply leverage over price or what can be termed pricing power is mainly due to price-efficiency that creates very small differentials—differentials that get smaller and smaller related to continuous market development. These very small differentials in turn are used to ration as well as assure a remaining availability of that supply over time. The changes are indeed very subtle and almost unrecognizable outside of the economic doctrine that says that it is what and will occur. Any direct supply risk then forces an immediate chain reaction that negates all the earlier market work, which forces those on the supply shortage side to exit at price change differentials that are disproportionably larger. Those on the fortunate side, however, clearly gain advantages beyond any immediate price as most likely the market will shift back to demand differentials (after the supply surge), and the demand differentials will not be large or consistent enough to bring about a retracement to or through the original starting point. The fundamental difference is that in the price efficiency model, the information related to the rationing is not well detectible on the surface while that related to supply is.

The relationship between supply, price, and time is refereed to herein as “time-distance.” As time-distance increases between price and supply, price become more random (because there are more unknown factors to take into consideration). Finally, at a significantly forward time the relationship is broken and price of a standard contract becomes nominal (quotable, but the contract is no longer usable for risk management). It is not until the end or near the end of standard contract duration that supply approaches an equal or greater importance to price because the supply according to contract specifics can be taken from the marketplace. The pricing differentials will be larger reflecting this added risk if it is so present.

At an organic level, however, supply is the key element in any such contract because, without supply, meaningful price activity cannot take place. Having supply in the background, as it is in standard contracts, allows the two-sided balance that comes from market rotation (e.g. prices going up and down in equal increments) to find efficiency and ration supply so that there is always availability. Supply therefore offers a more direct economic base from which to start, and a need exists to be able to engage this focus.

The combinations and limitations that can take place between standard elements, namely quality, quantity, duration, delivery time, delivery location, price, and related pricing derivatives, provide more flexibility than just price alone if each element is greater or less than an ordinary fixed standard. This creative process is the means at hand that can greatly expand the industry product base, and these complex products offer an ever-increasing challenge related to efficient access. An all-inclusive price risk chain includes many independent risks: by highlighting the most dominate element in a contract—the amount of crucial (i.e. partialized) supply—and allowing for a small change to potentially leverage a contract, the broad market price risks become subservient to a more activated supply. A defined economic beginning can be brought through the remaining gauntlet of risk by means of navigation rather than by a random, indirect course. Therefore, contracts that highlight partial or designed supply potentially have a more direct benefit, a more created than found use, more diffusion as it relates to concentration, and thus would provide benefit to the industry by making a limited product base much larger.

Price efficiency is the hallmark of actively traded markets as it provides access at the best price possible. Early, or the most recent price differences, that are both high and low, create transparent references so that subsequent trades can be evaluated to a created whole, as buying and selling are integrated into a fair price(s) in one continuous step. This procedure introduces time as a cost to past references that are the foundation of random activity—no market advantage within the structure of immediate price discovery. This process has again been defined as liquidity and it is very important for an exchange to maintain this environment in most all but the most unusual circumstances.

The liquidity process is one of finding and maintaining a balance in the market as the market continues forward. Being balanced going forward is a necessity as any new imbalance (for example, orders of a large nature or a series that is one way) can be more easily absorbed or incorporated into the developing structure without causing a greater than normal time lag (interruption—like stocks closing for an order imbalance) in continuous operations, which would change the random status that insures an efficient access price. It is order imbalances such as this as well as complex order entry problems that the invention addresses with a market based solution.

The integration of both buying and selling into an efficient price allows the accumulated zero sums that are related to the transactional base to be continually fragmented into smaller and smaller increments in this process of striving for balance. The uncertainty related to random prices associated with the future allow market nomenclature to rotate up and down, testing the depth of buying/selling, which is the continuous process of price range development that assures market balance. Multiple trades at same prices at different times above and below the balance point reduces by fragmentation the zero sums at each price, and balance assures that zero sums above and below the medium of the developed range will be roughly equal as there is a buyer and seller at each price, and going forward not all buyer are winners nor are all sellers losers. In this manner those holding positions will compete equally for each new access order with those who have placed orders that are slightly above or below the current market prices.

An illustration of access imbalance related to float supply, for example, is if 1000 contracts for soybeans are purchased once every year, this entry will have little if any effect on price because it does not threaten supply. If 1000 contracts are purchased every month or even every week, this still has little or no effect on price for the same reason. If 1000 contracts for soybeans are purchased every hour, the impact upon the market will be high. A trade sequence of this nature is not interested in price, but rather on ownership of the product regardless of price. The markets were not designed for this type of access, as internal balance would be destroyed because the float would be gone and have to be replenished at the cost of time to the market. Those long in the liquidity process would have all the profit, and those short, the loss. The market would have to begin searching for new supply instead of rationing it. Time-distance has collapsed from future pricing uncertainty to the certainty of the present, which then negates the needed random conditions. Pricing differentials would be greater on the upside changes and far less on those to the downside, which would have many negative effects upon the discovery process, especially as it relates to fragmentation of zero sums.

It essential to restore or maintain the existing time-distance of pricing uncertainty when faced with unusual circumstances related to market access. Trades now need to be serviced as related to quantity and price in an open and transparent pricing structure without destroying or removing the available supply that assures just that. Complex trades, trades of a block nature, trades related to settlement pricing, etc., all offer a direct challenge to the static situational liquidity that markets have today to deal with the new desired access in a fair and competitive way. When used herein, the term “complex order” refers to such potential imbalances as unusual trades, difficult trades, multiple component trades, overbearing trades, block orders, settlement pricing, normal arbitrage, etc.

The economic conflicts that arise today are between two different levels of economic activity that have traditionally been separated—that of price-efficiency and that of allocation, and the new desire of the industry to repackage or engineer products to increase the overall product base within the industry. It is impossible to fit a growing mass of trading dollars into a single price; therefore financial engineers have moved to tinker with the supply, which at the minimum allows some of the whole to be accessed, and at the maximum, can actually make the whole of supply a small float. Markets have always traded a multiple of float, so it is within possibilities that it can do the same for an entire market supply, and at times may have to. The need is to create flexibility surrounding whatever base the market is using, and that flexibility is time related to guaranteed price and quantity.

The traditional price-efficient market is one of balance, developed equilibrium, buttressed by time-distance price uncertainties. The traditional price efficient market produces efficient prices, rations demand, assures constant availability, and a remaining supply. Allocation on the other hand is the higher form of market economics of the two, and incorporates time as a discipline instead of price. Time as a cost is the common ground between the sets of economic conditions; in the former, it is the cost related to reference information, and the latter, it is the cost of overstaying; therefore time is the element that can offer a solution.

Allocation, when active, has more capital which can be termed sitting or holding capital, where price efficiency uses far less, and mandates a high competitive turnover among participants. Some created products—like U.S. patent application Ser. No. 10/062887 titled “Composite Commodity Financial Product” filed 31 Jan. 2002 and published as U.S. Patent Publication No. 2003/0154153—do not impinge upon either set of economic conditions because they remain passive after access as they are once removed from the organic fray of continued market development. These products rely upon cash flow design—supply pricing differentials for directions and demand pricing differentials for retracement, and thus a created time leverage related to very short or minimal time-distance—all at the same zero line or starting point. All created products allow the industry to grow by creating rather than finding opportunity, and most of these products will be individualized from components that could not stand-alone to the same amount of access pressure. Most of these products will be created at desktops thus giving them an individualized characteristic so needed when the pool of capital greatly exceeds the base supply within the industry. For example, the U.S produces $25 billion dollars of corn while all hedge funds have capital exceeding a trillion dollars. The contract markets need the power of creation, which will allow varied usage of the components, and thus reducing direct pressure on supply related to increased capital use.

When the nature of access changes to that of wanting supply instead of price, the marketplace is forced to do less in order to maintain order. It creates a one-sided randomness instead of the normal two-sided randomness, and is able to focus that randomness upon whether the next buying order will appear versus creating the uncertainty on the availability of either. This greatly reduces the uncertainty-surrounding price, and directly impacts the random nature of price change.

Instead of blending buy and sell orders into a balanced price structure as has been the norm, the market moves ahead and attempts to gain control over whatever supply imbalance is occurring without regard to the opposite side (either buying or selling) because float is being threatened. The market has to move sharply from ever changing bases (higher/lower) versus using that of using long established past references. The market does so in a series of vertical steps, which are expressly more non-random because the force (imbalance) has that character, and the fact that that the market needs to protect, gain or shed supply. The market does this to gain control, and the control is expressed by reduced time-distance measurements after each successive step i.e. higher prices with nearer references after each changed base.

The market will take on the character of an invader if the invader has more capital. Those that use the market the most will get outcomes that reflect those principles or fundamentals, whether positive or negative. If price efficiency is not such a goal, it gets pushed aside. Non-price sensitive trades are much harder to bring into balance, and if a concern arises related to supply due to immediate demand for supply at non-contractual times, related access would be compromised, and the functionality of the market could be severely questioned.

In essence, this change illustrates that the buying and selling do take place separately in the atmosphere related to supply questions versus the dual nature related to those of price, and that the market has to use time in order to rectify these events now so that balance can again go forward. The market first shuts off one activity, then shuts off the other, thus blending much farther out forward in time if at all—the market is now late and far less efficient as the next reference need to be found instead of being related to.

In attempting to redress these phenomena related to managing risk, the industry has moved increasingly toward a supply solution like indices, exchange traded funds (ETFs), or to where hedge funds are buying the whole of the company versus just some of its stock, etc. as supply offers leverage over price. Economic forces are constantly moving toward the edges in order to define new opportunities, and as a practical matter where supply imbalances are concerned related to markets, they offer a real measurement versus none at all in balanced (random) ones; therefore, more activity rather than less can be expected along these lines. While helping to address the phenomena, the need exists to expand these phenomena with a better economic basis than the focus in standard prior art contracts on price and its sole relationship to time. What is thus needed is a contractual basis that provides an additional economic front than the present focus in standard contracts of just liquidity related to price/time; the contractual bases needs to expand to include a relationship to supply/time.

### SUMMARY OF THE INVENTION

A contractual basis in accordance with the principles of the present invention provides an additional economic basis than the more limited focus in standard prior art contracts on price and its relationship to time in a liquidity environment. A contractual basis in accordance with the principles of the present invention diminishes the adversarial nature related to differing or competing economics to the accessing of standard contracts of the prior art in that such contractual basis has the potential to be beneficial to each individual participant related to varied economic interests of access by creating a more direct way to offset the immediate zero sums imposed upon the market by the direct use of supply.

In accordance with the principles of the present invention, a trading rights facility is provided. The trading rights facility of the present invention effectively limits the conflict between price efficiency, allocation, and complex products by diminishing the time imbalance related to any potential supply variance related to the immediate marketplace. The trading rights facility of the present invention borrows time from allocation where there is no immediacy in order to cover the time that is imposed upon the price-efficiency side of the market because supply would no longer be a nominal issue, thereby adding a immediate time lag to the price efficiency nomenclature of the market, with all the negative effects described earlier. Resolving the immediate supply issue allows the uncertainty of time-distance to remain within the pricing structure. The trading rights facility of the present invention adds time to complex transactions that are accessing some element or degree of supply through the normal price discovery process. The time added allows for a separation of competing economic functions before complete integration thus allowing the price functionality to continue versus being absorbed. The trading rights facility of the present invention intervenes between imbalances related to supply, facilitating multiple component product access, and allowing for balance to be maintained as a continuing and vital entity related to price discovery as the market goes forward in time. The supply imbalance is defined as a condition where the market is forced to search for some degree of supply first before it can do its more normal pricing operations.

The trading rights facility of the present invention comprises guaranteeing an access for the quantity and price of a potential imbalanced or complex order, which price is acceptable to both the buyer, the seller, and the market as a whole; and agreeing to fully deliver the quantities at the discovered price within a pre-set delayed time frame. In effect, the trading rights facility of the present invention creates a secondary “liquidity base” that augments the ordinary access pool, and allows for that initial liquidity base to remain untouched by the complex order itself, which is in sharp contrast to current experience where it would take all and ask for more. In this manner, the integration of buyers and sellers would remain a one-step integrated process to the market, therefore the efficient pricing model would not be pushed aside due to lack of greater-than capital. The initial liquidity base would be there to cushion the access community and the pricing differentials would be mostly related to demand after an initial adjustment to that of supply (e.g. premium/discount expansion/contraction). The complex access would be at a premium/discount to current market price(s) and would be competitively bid in relation to the whole of the initial liquidity base environment. The trading rights facility of the present invention ensures the transparency of all operations.

In further embodiments, the trading rights facility of the present invention further allows for the creation for a variable access index product that also provides a supply zero sum diffusion base, and the trading rights facility of the present invention allows a contract on a settlement price to be traded before the settlement price has been derived.

### DETAILED DESCRIPTION OF THE PREFERRED EMBODIMENTS

This application incorporates by this reference two financial products, the disclosure of previously referenced U.S. patent application Ser. No. 10/062,887 titled “Composite Commodity Financial Product” and the disclosure of U.S. patent application Ser. No. 10/351,949 Titled “Leveraged Supply Contracts” filed 27 Jan. 2003 and published as U.S. Patent Publication No. 2004/0148236, which are prior examples that demonstrate the supply integration into products that the markets are facing.

Market time, which in reality does not exist as it is always in the immediate and therefore allows no real market measurement (random), is ironically maintained by the addition of a time margin that facilitates a workable time time-distance relationship between price and supply. As described above, market time is the new critical element and the foundation of a trading rights facility in accordance with the principles of the present invention. As used herein, the term “market” includes any kind of trade, exchange, buying, selling, and transacting, as well as systems or entities that facilitate, accommodate or allow such activities. A trading rights facility in accordance with the principles of the present invention effectively limits the inherit conflict between competing economic force (price efficiency (balance), allocation (imbalance), and complex contracts (passive but in need of more immediate access)) by moving any real or potential time imbalance from the immediate marketplace to the sidelines.

A trading rights facility in accordance with the principles of the present invention effectively borrows time from allocation, thus diminishing the need to change preexisting price efficiency nomenclature of the market. A trading rights facility of the present invention removes the potential immediate negative effect from complex orders thus allowing the market to knowingly incorporate them into future pricing over the time-allotment of the delay. In this manner, the trading rights facility of the present invention does not totally eliminate the initial price shift (e.g. premium or discount accepted by the market) between price-efficiency and allocation, but deals with the problem in a manner acceptable to the market itself—the trading rights facility of the present invention lets the market accomplish it.

A trading rights facility in accordance with the principles of the present invention intervenes between known potential imbalances such as for example unusual trades, difficult trades, multiple component trades, overbearing trades, block orders, settlement pricing, normal arbitrage, etc. that were previously defined as “complex orders” or transactions. A trading rights facility in accordance with the principles of the present invention facilitates multiple component product access and allows for balance to be maintained as a continuing and vital entity related to price discovery as the market goes forward in time. A trading rights facility of the present invention does this by guaranteeing the access price of the complex order, which price is acceptable to both the buyer, the seller, and the market, and by guaranteeing to fully deliver the quantities at the discovered price within a pre-set delayed time frame. All operations of a trading rights facility of the present invention are transparent and made available to all market participates at the same time.

In accordance with the principles of the present invention, and assuming a buy order, a seller(s) agrees to sell at a premium to the immediate market price to a buyer that is guaranteed as to price and quantity by a trading rights facility of the present invention where delivery of the actual will be delayed to an agreed upon or preset amount of time. The seller(s), as well as all market participants, then has access to all selling orders versus the buyer having taken all selling orders and asking for more, which would leave the residual market maker at the mercy of a market with no immediate supply. The market is in position now armed with the information of the trade, the time-distance uncertainty that is still in place to incorporate both buying and selling as no one is assured what the next price or series of price changes will bring—the random conditions have been maintained. In the past, the role of the residual market maker has evolved from pure scalper, to market maker, and finally a creative arbiter because of the supply problem related to the “pool”, book or deck liquidity base—in that something else needs to be bought against the exposure of the earlier trade as all supply of that product has been taken out and the singularity of market activity when supply is in question, as explained above, can only move further against the market maker in that the market has to insure a shutoff, and shutoffs usually come at higher prices.

A trading rights facility in accordance with the principles of the present invention in effect creates a “liquidity base” as a counter-balance against complex orders. The trader, providing access, is granted a “privilege” for a period of time (for example 5 days) to fully incorporate the trade into the marketplace, as the trading rights facility has stepped up to guarantee the price and quantity. The delayed-delivery step by a trading rights facility in accordance with the principles of the present invention allows for the seller—the market maker or arbiter—to reduce his uncertainty to just a part of the whole of the transaction as the price differential premium for delayed delivery is in place as a known to the current pricing structure offsets available. The competitive nature of access will remain within that of smaller pricing-differentials as those related to supply have been reflected in the premium. The risk of transactional integrity to the participants as well as to the newly created trading rights facility of the present invention is minimal in that the all the markets already have clearinghouses that have already guaranteed both traders. A trading rights facility of the present invention will lead to not only better prices for these and all subsequent transactions, and will ensure the ability of price discovery to service a broader and more diverse participant base. The additional growth will not come at the expense of the present as so often occurs in free market societies.

The time element or privilege that has been inserted can be part of the market functionality—i.e. can be bid or offered competitively—and will only suffer when time element is too short. Overuse of this time element has no downside; therefore it does not need to be a direct market consideration and can be set by the trading rights facility of the present invention. It will expire once it usefulness is over, and all activity will merge back to where it was before the process began into what now can be called a consolidated market having much more diversity of purpose related to market access.

The market related to time is one where time is a cost related to references in price-discovery, and a market of over-staying when related to allocation. In price discovery, the market establishes two references: one high and the other low. Once established, these references are used by the market to find efficient prices where pricing differentials get less and less as compared to earlier when pricing differentials were larger. The market, if broken down in terms of time development, will show smaller period ranges later in development as compared to earlier when the market needed to establish the two above references. This defined activity helps illustrate the cost of time in that the high and low are not often repeated prices (i.e., they are used at lot less than other development prices), and as subsequent price differentials move away from those measurements, the price differentials become smaller. Characteristics of a price discovery market are equilibrium, no real time measurements, small random price differential changes, and a cost related to time.

Allocation, on the other hand, uses time rather than price as a discipline and as a consequence is imbalanced, as its capital commitment is never equalized through time (it is always one-sided: buying or liquidation). The time costs in almost all instances will be overstaying the period of most favorable development. Allocation also needs a time measurement, which is possible if one were to measure order flow related to access time—a time measurement where the rate of access is increasing or decreasing related to that static time measurement. The initial reference is the starting point, a further time tolerance is a reference that serves to further enhance measured development related to continuation of access, and additionally acts as a reference where it violates whatever time continuation parameters have been put in place. The noise related to random market development is tuned out, as are its prices. This type of time measurement allows use of time as a lever, which offers internal rather than external leverage. All increments of time leverage offer increased returns versus those of an external nature—no gradual diminishing return, which further defines allocation's non-random atmosphere.

A trading rights facility in accordance with the principles of the present invention intervenes with allocation by borrowing some time from it, and gives this time to market makers, arbitrageurs or locals so that they can integrate a supply imbalance into the marketplace without reducing the uncertain nature that is so important to price discovery. This transfer of time does not affect the economics related to allocation, and the transfer of time strengthens and further defines the twin references (established high/low references) related to price-efficiency development by allowing the references to be in place longer. A trading rights facility of the present invention helps bring into balance the larger price change differentials related to supply and the smaller price change differentials related to demand, and additionally reduces everyday price premiums related to the risk of some degree toward the float/potential order imbalance. The potential supply imbalance activation is no real surprise to the price access system when it occurs in that the secondary liquidity base moves in tandem with current price development and is fully transparent. In this manner, access for complex orders can benefit from price efficient access, which has long served the industry. A trading rights facility of the present invention produces a net economic gain because it illustrates the benefit of bringing both factions together on a common ground of time management, which then allows for a market-based solution that will be worked out between all parties.

This secondary (new) book flex is an important information source in that people with large capital to commit are generally afraid of transparency, yet transparency has been a hallmark of free markets for a long time. A placement offers a limited transparency that is self-serving to both parties, while market transparency offers a broader competitive pricing structure for the same trade. At first, the market makers will list offers and bids related to access to the index, next the more varied possibilities related to accessing contract flexibility within the index itself would be listed. These varied trade opportunities will offer a wide array of supply that can be traded within itself or reach out to other venues. The expression of additional interest will be in the form of premium/discount differentials related to the ordinary pricing differentials that are produced within an efficient marketplace. The fact that both supply imbalance and price balance are now transparently related can only lead to greater usage and growth for the industry. The object is to move away from the absolute zero sums that can be crudely put as “you win, I lose,” and offer a more diffused base—especially when related to supply pricing differentials. When large zero sums are created in the marketplace, which the market cannot fragment, the zero sums degrades the whole process for all concerned. The best solution is steeped in transparency because transparency allows the market to produce fair access to all versus a few.

As is known in the art, trading rights facility in accordance with the principals of the present invention can be preferably embodied as a system cooperating with computer hardware components, and as a computer-implemented method.

### Additional Embodiment

In a further embodiment, a variable access index can be created that is guaranteed by a trading rights facility in accordance with the present invention. The variable access index is made up of underlings, such as for example grain contracts, financial instruments or stocks that are tied to varied opportunities related to specific times (e.g. contract expiration), and in and of themselves are imbalanced portfolios (e.g. long/short/varied quantities) as is the nature of access. A separate liquidity base related to supply needs is best met by diffusing the zero sums versus the more normal fragmentation process now employed by standard contracts, which allows buying and selling up to the underling gross amount in any context rather than just direct buying and selling of the particular index as would normally be the case.

In one embodiment, a financial index that can be referred to as a variable access index can be created where the index is guaranteed by a trading rights facility in accordance with the present invention. The variable access index is made up of underlings, such as for example grain contracts, contracts, financial instruments or stocks that are tied to varied opportunities related to specific times (e.g. growing season-supply and demand-after harvest), and in and of themselves are imbalanced portfolios (e.g. long/short/varied quantities) as is the nature of access. A separate liquidity base related to supply needs is best met by diffusing the zero sums before the more normal fragmentation process now employed by standard contracts begins, which is accomplished by allows buying and selling up to the underling gross amount in any context rather than just direct buying and selling of the particular index as would normally be the case. The contractual time periods for these indices can be divided into periods where either supply or demand is the focus, which further simplifies the isolation of risk to the participants. The formal (designated make up) index can be marked to market related to entry and exit of those selected time periods. The index can be quoted at a market-determined premium of bids and offers related to a single index product to the underlings as well as to the multiple combinations now made available.

As is known in the art, a variable index access in accordance with the principals of the present invention can be preferably embodied as a system cooperating with computer hardware components, and as a computer-implemented method.

### EXAMPLE

An example of a variable access index can be based on the grain markets at the Board of Trade of the City of Chicago, 141 West Jackson Boulevard, Chicago, Ill. 60604-2994 (CBOT) which assumes that the CBOT acts as principal of a trading rights facility in accordance with the present invention. To increase its product base the CBOT has created a format with grain contracts to form an index that represents both seasonal opportunity and the cost of time related to investment. The index is for a specific period of time, and is designed to be marked to the market related to the entry and exit of that same time period. The duration of this index is related to the fundamental nature of the growing season or one that is supply focused. The index also reflects the growing need for those resources in an economic environment where standards of living are increasing relative to population growth in the global marketplace.

As a more specific example, one contract of the index could be composed of 100 standard contracts, where for example 40 contracts are long soybeans, 25 contracts are long soy meal, 25 contracts are short wheat, and 10 contracts are short soy oil. The index could have a staggered closing due to the inclusion of July wheat (because the July wheat contract expires that month), and can be comprised of November beans, December soy oil and meal, and July wheat. The duration will be related to the growing season so it will start January 15 and end July 15. The new index market will be quoted at a market-determined premium of bids and offers related to a single index product to the components. The premium will be a singular amount to the 100 components—for example $75 per contract bid offered at $90—the amount or quantity would also be listed along with the bid or ask in the new pool. The obligated premium will be based upon the last whole traded price with no fraction, which will provide tremendous flex and help integrate both markets into the desirous singular price that can continually represent fair access by extending the creative reach of the market maker, etc. Another form of flex will be that bids/offers can be for 100 contracts of any mix or make up versus the fixed makeup of the index (e.g. 7 index contracts for 100 soybeans each or 700 beans long). In this manner, the more direct zero sums related to supply can be diffused by the diversity available within the new supply pool, thus mitigating by design the relative position of supply to the price discovery pool.

The market-maker, arbitrageur or local will have for example five trading days to delivery on the quantity-price obligation, which has been guaranteed by the trading rights facility of the present invention. The flex is dramatically increased in that rather than having the immediate consequence for the completed contractual obligation, the privilege of time accorded by the trading rights facility of the present invention allows for market development to integrate the complex order into a broader fabric of price discovery (i.e., the supply pressure has been diffused by time).

The trading rights facility of the present invention will accept the contracts to be delivered from the market maker and in turn re-deliver them to the index holder which fulfills his contractual right. The facility will also serve as a clearing facility in that the pay-collect differentials related to the transactions will be credited and debited with respect to the delayed transference of the actual contracts. The open interest of the standard contracts will provide the forward flex related to zero sums as the holders would constantly change over time thus providing the additional fragmentation to keep and maintain market balance. The increased rotational ability of the price discovery market will also enhance the same. Price information will be displayed and distributed the same as in the prior art except for the quantity to be added to the price in relation to all the bids, offers, and the completed transactions of all the varied access for the index trades. The bids and offers—premium per contract—above and below the current quote will also be referenced as premiums greater/less than, and include those of a more customized nature as discussed above. These bids and offers will always be in flux related to the most current market conditions and to those changes that take place within its own defined boundaries.

### Additional Embodiment

In a further embodiment in accordance with the principle of the present invention, a trade development package can be offered. In this further embodiment, a trader can buy/sell the settlement price before the settlement price has been derived. In accordance with the principles of the present invention, a liquidity base of counter orders is derived. All trades in accordance with this further embodiment are transparent; that is, are disclosed to the market. The settlement price is derived in accordance with this information. Thus, traders are afforded the opportunity to hedge against the settlement price by trading them.

A settlement price does not exist within the framework of market development; therefore a settlement price cannot be an access price as are all prices when the market is open to trade. A settlement price occurs after the market as a settlement to last few minutes of trade activity. The settlement price represents the financial ending of the activities of the day, and all pay, collect, margins, etc. are based upon the settlement price. Many of those accessing markets would like to use settlement price as an access due to this importance.

A trade development package in accordance with the present invention provides participants who want such exposure to participate passively in its development. In a trade development package of the present invention, a set period of time before the market closes (say, 15 minutes), participants could list the quantity of buying or selling desired at settlement. The amount (quantity) would be guaranteed by the trading rights facility of the present invention. The market makers would commit to the amount and trade would proceed as normal. The disclosure would be transparent to all, and would help in developing the references needed for orderly development of that price. The price development would move toward a fully disclosed ending where the final price would be based up uncertainties of that time distance (in the example, 15 minutes). Settlement, in this case, would be traded as the obligated parties (market makers) would be using settlement to complete their transactions, and the access right of the early listers would be completed at that same price thus ending all obligations of the guarantee by the trading rights facility of the present invention.

As is known in the art, a trade development package in accordance with the principals of the present invention can be preferably embodied as a system cooperating with computer hardware components, and as a computer-implemented method.

### EXAMPLE

In this further embodiment, a trader can list 15 minutes before the settlement price is to be derived a buy for 1000 contract for soybeans desired at settlement. In accordance with the principles of the present invention, a liquidity base of counter orders is derived. For example, to trade using the settlement price a trader can agree to sell 200 contracts of soybeans 15 minutes before the settlement price is to be derived, which 200 contracts comprises a portion of the counter trade liquidity base. The settlement price will be the access price for both parties.

Once established, a trading rights facility of the present invention would service the spectrum of complex access that would service the field of allocation (where growth beyond access lies). This secondary “liquidity base” would make the primary access arena more efficient in that information related to the new related liquidity base would be now be part of the informational discovery process. Trading rights would be active rather than passive in creating a trading base for high margin exchange products, and would be the internal growth engine that would bring reliability and consistency to exchange earnings.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A trading rights facility that effectively limits the conflict between price efficiency and allocation by diminishing the time imbalance from the immediate marketplace.

2. The trading rights facility of claim 1 further comprising guaranteeing an access price of an imbalanced order, which price is acceptable to both the buyer, the seller, and the market; and agreeing to fully deliver the quantities at the discovered price within a pre-set time frame.

3. The trading rights facility of claim 1 further comprising creating a “liquidity base” within a pre-set time frame as a counter-balance against disruptive orders.

4. The trading rights facility of claim 1 further comprising transparency of all operations.

5. The trading rights facility of claim 1 further comprising allowing a settlement price to be traded before the settlement price has been derived.

6. A trading rights facility comprising borrowing time from allocation, whereby diminishing time from the price efficiency nomenclature of the market.

7. The trading rights facility of claim 6 further comprising guaranteeing an access price of an imbalanced order, which price is acceptable to both the buyer, the seller, and the market; and agreeing to fully deliver the quantities at the discovered price within a pre-set time frame.

8. The trading rights facility of claim 6 further comprising creating a “liquidity base” within a pre-set time frame as a counter-balance against disruptive orders.

9. The trading rights facility of claim 6 further comprising transparency of all operations.

10. The trading rights facility of claim 6 further comprising allowing a settlement price to be traded before the settlement price has been derived.

11. A trading rights facility comprising adding time to a disruptive transaction that originated as part of the discovery process rather than having the time element remain part of the whole of that same process.

12. The trading rights facility of claim 11 further comprising guaranteeing an access price of an imbalanced order, which price is acceptable to both the buyer, the seller, and the market; and agreeing to fully deliver the quantities at the discovered price within a pre-set time frame.

13. The trading rights facility of claim 11 further comprising creating a “liquidity base” within a pre-set time frame as a counter-balance against disruptive orders.

14. The trading rights facility of claim 11 further comprising transparency of all operations.

15. The trading rights facility of claim 11 further comprising allowing a settlement price to be traded before the settlement price has been derived.

16. A trading rights facility comprising: intervening between imbalances; facilitating multiple component product access; and allowing for balance to be maintained as a continuing and vital entity related to price discovery as the market goes forward in time.

17. The trading rights facility of claim 16 further comprising guaranteeing an access price of an imbalanced order, which price is acceptable to both the buyer, the seller, and the market; and agreeing to fully deliver the quantities at the discovered price within a pre-set time frame.

18. The trading rights facility of claim 16 further comprising creating a “liquidity base” within a pre-set time frame as a counter-balance against disruptive orders.

19. The trading rights facility of claim 16 further comprising transparency of all operations.

20. The trading rights facility of claim 16 further comprising allowing a settlement price to be traded before the settlement price has been derived.

21. A trading rights facility comprising guaranteeing an access price of an imbalanced order, which price is acceptable to both the buyer, the seller, and the market; and agreeing to fully deliver the quantities at the discovered price within a pre-set time frame.

22. The trading rights facility of claim 21 further comprising creating a “liquidity base” within a pre-set time frame as a counter-balance against disruptive orders.

23. The trading rights facility of claim 21 further comprising transparency of all operations.

24. The trading rights facility of claim 21 further comprising allowing a settlement price to be traded before the settlement price has been derived.

25. A trading rights facility comprising creating a “liquidity base” within a pre-set time frame as a counter-balance against disruptive orders.

26. The trading rights facility of claim 25 further comprising transparency of all operations.

27. The trading rights facility of claim 25 further comprising allowing a settlement price to be traded before the settlement price has been derived.

28. A trading rights facility that comprising allowing a settlement price to be traded before the settlement price has been derived.

29. A variable access index comprising:
an underling that is tied to seasonal opportunity at a specific period of time;
the index marked to market related to entry and exit of the time period;
the index quoted at a market-determined premium of bids and offers related to a single index to the underling; and
guaranteeing a quantity obligation through a trading rights facility.

30. The variable access index of claim 29 further wherein part of the time periods are supply focused and part of the time periods are demand based.

31. The variable access index of claim 29 further wherein the underling is a commodity.

32. The variable access index of claim 31 further wherein the underling is a grain.

33. The variable access index of claim 31 further comprising multiple underlings.

34. The variable access index of claim 33 further wherein the multiple underlings are commodities.

35. The variable access index of claim 34 further wherein the multiple underlings are grain.

36. The variable access index of claim 33 further wherein the multiple underlings are selected from the group comprising soybeans, corn, wheat, soybean oil, soybean meal, oats, ethanol, rice, bonds, notes, swaps, metals, financial products, and financial indexes.
